(19) United States
(12) Patent Application Publication
(10) Pub. No.: US 2010/0021261 A1
(43) Pub. Date: Jan. 28, 2010

(54) Flat ring-shaped anchoring element

(75) Inventors: Pietro Bianchi, Gams (CH); Roger Tognini, Heerbrugg (CH); Bernhard Sander, Munich (DE); Clemens Lutz, Werdenberg (CH); Joerg Appl, Fruemsen (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/460,463

(22) Filed: Jul. 16, 2009

(30) Foreign Application Priority Data
Jul. 24, 2008 (DE) 10 2008 040 677.5

(51) Int. Cl. F16B 13/04; F16B 39/24

(52) U.S. Cl. 411/78; 411/160

(57) ABSTRACT

A flat ring-shaped anchoring element (11; 31; 71) for mounting on a shaft (52; 62) of a fastening element (51; 61) provided with an outer profile (53), includes a through-opening (12; 32) for the shaft (52; 62) and at least one compensation recess (13; 33) located radially outwardly of the through-opening (12; 32) and opening thereto.

### BACKGROUND OF THE INVENTION

1. Field of the Invention

The present invention relates to a flat ring-shaped anchoring element mountable on a fastening element shaft provided with an outer profile, the anchoring element having a through-opening for the shaft. The present invention also relates to a fastening element anchorable in a borehole of a constructional component with a hardenable mass and provided with a least one flat ring-shaped anchoring element, and to fastening arrangement with a fastening element provided with an anchorable element.

2. Description of the Prior Art

It is known to chemically anchor a fastening element having a shaft with an outer profile in a borehole with a hardenable mass that is brought into the borehole before or after insertion of the fastening element in the borehole. The fastening element can be formed, e.g., as a threaded rod provided along its entire longitudinal extent with a thread that forms the outer profile. When such a fastening element is chemically anchored, a rupture can occur along a contact region between the shaft and the hardenable mass or along a contact region between the borehole wall and the hardenable mass.

Bonding of the hardened mass to the borehole wall and, thus, anchoring of the fastening element in the borehole can be improved by cleaning the borehole and, in particular, by cleaning the borehole wall. Cleaning of the borehole involves additional expenses and requires separate auxiliary means necessary to achieve advantageous results and which are not always available to the user.

U.S. Pat. No. 1,688,087 discloses a fastening element anchorable in a borehole with a hardenable mass and having a shaft with a thread-shaped outer profile and a plurality of flat ring-shaped anchoring elements each having a through-opening for the shaft and an outer diameter greater than a nominal diameter of the borehole in which the fastening element is being anchored. The fastening element is inserted in the borehole as a unitary element, i.e., with anchoring elements being arranged on its shaft. The flat ring-shaped anchoring elements provide for mechanical anchoring of the fastening element in a borehole until the hardenable mass, which was introduced in the borehole before or after the insertion of the fastening element, sufficiently hardens. In addition, the anchoring elements provide for reinforcement of the hardenable mass which insure additionally higher pull-out value.

The drawback of the fastening element described above consists in that in view of the outer profile of the shaft of the fastening element, the flat ring-shaped anchoring elements easily incline in a plane extending transverse to the longitudinal axis of the shaft and, as a result, the shaft section that projects from the borehole after setting of the fastening element, does not extend perpendicular to the surface of the constructional component. The subsequent adjustment of the shaft generally is possible only within certain limits as the adjustment is effected against a counter-force generated by the fastening element.

Accordingly, an object of the present invention is to provide an anchoring element that can easily be mounted on a shaft with an outer profile and which also permits to reduce the costs of setting of a fastening element.

Another object of the present invention is a fastening element having at least one inventive anchoring element.

A further object of the present invention is a fastening arrangement with a fastening element having at least one inventive anchoring element and which permits to reduce the setting costs.

### SUMMARY OF THE INVENTION

These and other objects of the present invention, which will become apparent hereinafter, are achieved by providing in the anchoring element described above, at least one compensation recess located radially outwardly of the through-opening and opening thereto.

The at least one compensation recess permits to compensate the pitch of the outer profile, which is provided on the shaft of the fastening element, so that the anchoring element extends, in a mounted condition, substantially perpendicular to the shaft or in a radial, with respect to the shaft, plane. The main plane of the anchoring element forms, in the mounted condition of the anchoring element on the shaft, with the longitudinal axis of the shaft an angle of about 90°. The at least one compensation recess adjoins the radial boundary of the through-opening and extends radially outwardly. Advantageously, the at least one compensation recess is formed as a notch or a slot limited on one side. An adjustment of the fastening element provided with at least one anchoring element after setting of the fastening element in a borehole in most cases is not necessary and, if necessary, can be easily carried out.

The through-opening preferably has a shape adapted to the shaft of the fastening element and can, thus, has a shape that deviates from a circle. Advantageously, the through-opening is concentric with the enveloping line that forms the circumference of the anchoring element. In an alternative embodiment, the through-opening is offset relative to the concentric arrangement, so that the width of the material section between the radial boundary of the through-opening and the enveloping line that forms the outer circumference of the anchoring element, varies.

Advantageously, the outer circumference of the anchoring element is provided with a shaped profile. This insures an easy adaptation of the anchoring element to the shape of the borehole. E.g., the shaped profile is formed by recesses that open radially outwardly. The recesses are advantageously formed as slots limited on one side and extending from the outer circumference of the anchoring element in a direction of the anchoring element center. The sections of the anchoring element which are located between the recesses, form easily deflectable lamellas.

Thereby, even if the anchoring element is formed of a very rigid material, the adaptation of the anchoring element to the borehole during insertion of the fastening element is insured. In an advantageous flexible embodiment of the anchoring element, the at least one compensation recess and the recesses that form the outer profile of the anchoring element, at least partially overlap each other. Advantageously, the shaped profile of the outer circumference can be formed by different kinds of the recesses. E.g., the shaped profile can be formed by slots that form flexible lamellas on the outer circumference of the anchoring element. Between these slots, another kind of slots can be provided that spread out the edge of the anchoring element therebetween.

Advantageously, the anchoring element has a wavy profile in the ring plane which insures a sufficient stiffness of the anchoring element, in particular, during insertion in a borehole despite the presence of the at least one compensation recess.

For an advantageous anchoring of an anchoring element against the wall of a borehole and/or for its securing on a shaft of a fastening element, the thickness of the anchoring element should amount advantageously to from 0.01 mm to 2 mm and, particularly advantageously, from 0.05 mm to 1 mm.

Advantageously, the anchoring element has different thicknesses in the ring plane, which permits to adapt the deformation characteristics of an anchoring element, in particular, during insertion in a borehole, to the site conditions. In a particular advantageous embodiment, the thickness increases radially outwardly, starting from the through-opening. As a result, in the contact region of the anchoring element with the borehole wall, there is available a sufficiently large amount of material for mechanical anchoring of a fastening element. According to another advantageous embodiment, the thickness of an anchoring element increases from the outer circumference in a radial direction toward the through-opening, whereby an advantageously large amount of material is available in the contact region of the anchoring element with the shaft of the fastening element for securing the anchoring element on the shaft. The thickness of the anchoring element can also increase from the through-opening radially outwardly, on one hand, and from the outer circumference radially inwardly, on the other hand. As a result, the region of the fastening element with the greatest thickness of material is located between the outer circumference and the through-opening.

Advantageously, in the anchoring element, there is provided at least one through-opening for a hardenable mass. As a result, upon insertion of the anchoring element in a borehole, which has already been filled with the hardenable mass, the forced-out portion of the hardenable mass easily penetrate through the anchoring element, and the anchoring element can be completely enveloped by the hardenable mass. When the borehole is filled with the hardenable mass after insertion of the fastening element, the at least one through-opening for the hardenable mass provides for an unhindered flow of the injected hardenable mass up to the borehole bottom.

According to an advantageous embodiment of the present invention, the at least one through-opening for the hardenable mass is provided at the outer circumference of the anchoring element. Alternatively or in addition, there is provided at least one circumferentially closed through-opening for the hardenable mass.

Advantageously, the strip for forming the anchoring elements is formed of metal, preferably of sheet steel. This insures that the anchoring element has a sufficient stiffness. A simple and economical manufacturing is insured, in particular, with the use of a stamping and bending process.

According to an alternative embodiment, the anchoring element is formed of a plastic material, preferably a fiber-reinforced plastic material. A simple and economical manufacturing of the anchoring element is insured, in particular, by an injection-molding process.

According to one of the advantageous embodiments of the present invention, the anchoring element is formed of a non-conductive material. In application in which no current should be transmitted, e.g., during attachment or securing of railroad ties, the strip-shaped anchoring element insures an adequate distance between the shaft and the borehole wall and the flow of current from the constructional component in the shaft of the fastening element.

Alternatively, the anchoring element can be formed of a material other than metal or plastic material, as long as it insures an adequate mechanical anchoring of the fastening element in the borehole until the hardenable mass is hardened.

A fastening element according to the present invention, which is anchored in a borehole with a hardenable mass, has a shaft with an outer profile and at least one flat ring-shaped anchoring element having a through-opening for the shaft and at least one compensation recess located radially outwardly of the through-opening and opening thereto.

Such a fastening element can be easily produced and insures its easy setting in a borehole of a constructional component, e.g., in a wall or ceiling. The outer profile of the shaft can be formed, e.g., as a thread.

The at least one flat ring-shaped anchoring element of the inventive fastening element can have separate and all of the features of the anchoring element described above.

Advantageously, a plurality of anchoring elements is provided on the shaft at a distance from each other. This insures an advantageous anchoring of the fastening element and a simple alignment of the fastening element in the borehole, as well as reinforcement of the hardenable mass. Advantageously, the anchoring elements are arranged on the shaft at uniform distances from each other.

Advantageously, anchoring elements of different shapes are provided on the shaft of fastening element. This permits to combine, if necessary, different anchoring characteristics at different depth. E.g., flat ring-shaped anchoring elements can be combined with sleeve-shaped and screw-shaped anchoring elements on the same shaft.

Advantageously, at least two flat ring-shaped anchoring elements are connected with each other at one of edge regions thereof, forming an anchoring assembly. The shaft is inserted through the connected with each other, flat ring-shaped anchoring elements. For connecting the at least two flat ring-shaped anchoring elements, they are, e.g., not completely separated from each other during the stamping-bending process or are connected with each other by a common connection point, e.g., a solder or glue point, or by a clamp or any other connecting element. Advantageously, more than two flat ring-shaped anchoring elements are connected with each other alternatively at their opposite edge sections. The distance of the anchoring elements from each other can be advantageously adapted to an anchoring length in a borehole by compressing the anchoring elements together on the fastening element or by pulling them away from each other.

The fastening arrangement of a fastening element in a borehole having a certain nominal diameter includes a fastening element anchorable in the borehole of a constructional component with a hardenable mass and having a shaft with an outer profile and at least one flat ring-shaped anchoring element having a through-opening for the shaft, at least one compensation recess located radially outwardly of the through-opening and opening thereto, and an outer diameter that is greater than the nominal diameter of the borehole.

During insertion of the fastening element in the borehole, the anchoring element-forming sheets, which are displaced along the borehole wall, simultaneously clean the wall, with the drillings being collected at the borehole bottom and, as the case may be, in the hardenable mass, and are not released any more in a large amount in the environment. A separate cleaning of the borehole before setting of the fastening element is not any more necessary, whereby high end loads are achieved with the fastening element. Further, the at least one anchoring element insures protection during insertion of the fastening element in the borehole against the spraying of the hardenable mass out of the borehole.

With the elimination of the cleaning step, the reliability of setting is increased and the setting process is accelerated. No additional tools are necessary, and the environment is not additionally stressed by drillings. In addition, the fastening elements insure, in particular when they are provided with a plurality of anchoring elements, an adequate covering of the shaft along its entire anchoring length with the hardenable mass.

The at least one anchoring element or a fastening element therewith can have separate and all features of the anchoring element described above or the above-described fastening element.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a plan view of a first embodiment of an anchoring element according to the present invention;

FIG. 2 a side view of the anchoring element shown in FIG. 1;

FIG. 3 a plan view of a second embodiment of an anchoring element according to the present invention;

FIG. 4 a cross-sectional view illustrating anchoring of a fastening element, using an inventive anchoring element; and

FIG. 5 a schematic side view illustrating anchoring of another embodiment of a fastening element, using an inventive anchoring element.

In the drawings, basically, the same elements are designated with the same reference numerals.

### DETAILED DESCRIPTION OF THE PREFERRED EMBODIMENTS

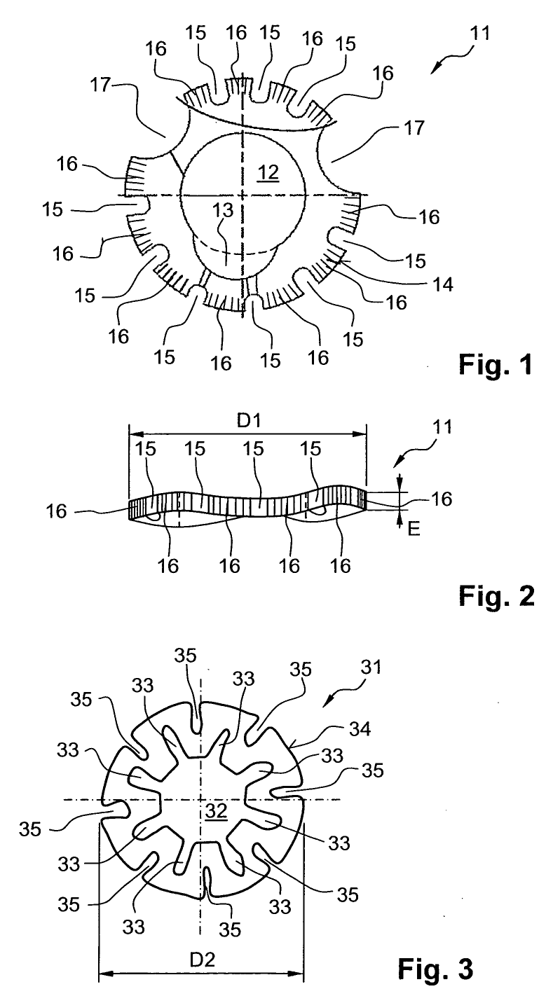

A flat ring-shaped anchoring element 11 according to the present invention, which is shown in FIGS. 1 and 2, has a through-opening 12 for a shaft of a fastening element, and a compensation recess 13 that adjoins the through-opening 12 at the radial boundary of the through-opening and that is formed as a notch opening radially inwardly. The outer circumference 14 of the fastening element 11 has a profile in form of opening radially outwardly, recesses 15 which are formed by a plurality of slightly bent lamellas. Between a major portion of these recesses 15, there are provided slots 16 extending radially inwardly from the outer circumference 14 of the anchoring element 11. The slots 16 spread out the free edge of the anchoring element 11, at least in some regions, thereby enabling an easy adaptation of the anchoring element 11 to a borehole wall. The outer circumference 14 of the anchoring element 11 is provided with two further through-openings 17 for a hardenable mass. The anchoring element 11 has an outer diameter D1.

In the ring plane, the anchoring element 11 has a wavy profile (see FIG. 2) and has different thicknesses. In the embodiment of the anchoring element 11 shown in FIGS. 1-2, the thickness, starting from the through-opening 12, increases in the radial direction outwardly.

The anchoring element 11 is formed of metal, preferably of sheet steel, by a stamping-bending process.

In a set state, the anchoring element 11 is completely surrounded by a hardenable mass 43 so that even at a small material thickness E, blow-up of the anchoring element 11 under a load is prevented already before a complete hardening of the hardenable mass 43.

A flat ring-shaped anchoring element 31, which is shown in FIG. 3, likewise has a through-opening 32 for a shaft of a fastening element and is provided at its radial boundary with a plurality of extending radially outwardly slots which form compensation openings 33. In order to form a plurality of easy deflectable lamellas at the outer circumference 34 of the anchoring element 32, there is provided a plurality of slot 35 extending radially inwardly from the circumference 34. In a plan view, the compensation recesses 34 and the slots 35 partially overlap. The anchoring element 32 has an outer diameter D2.

The anchoring element 31 is formed of a plastic material, preferably, of a fiber-reinforced plastic material, by an injection-molding process.

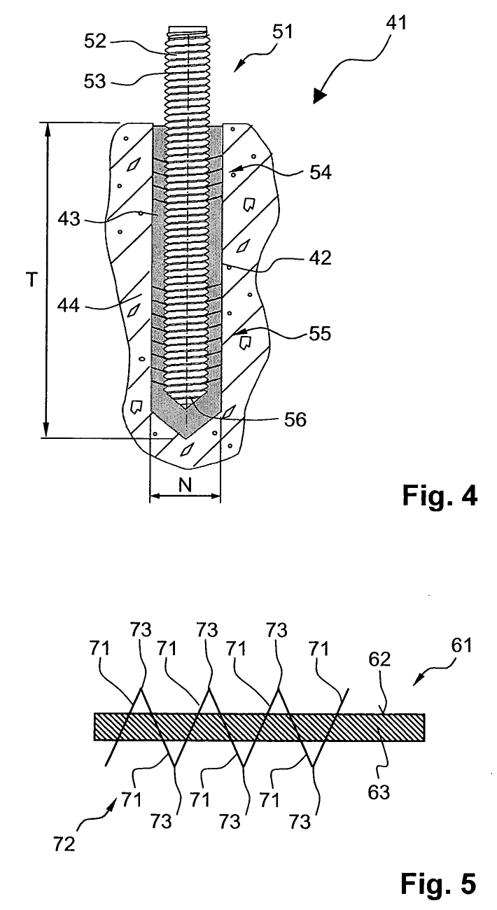

FIG. 4 shows a fastening arrangement for anchoring a fastening element 51 in a borehole 42 with a hardenable mass 43.

The fastening element 51 has a shaft 52 with an outer thread that forms an outer profile 53, and is provided with a plurality of spaced from each other, anchoring elements 11 which are divided in two groups 54 and 55 and are arranged on the shaft 52. The group 55 of the anchoring elements 11 provided on the shaft adjacent to the setting direction end 56 of the shaft 52 and the group 54 spaced from the group 55 each includes several, uniformly spaced from each other, anchoring elements 31.

One of the groups 54 and 55 can be formed of anchoring elements having different shapes, e.g., of anchoring elements 11 and 31. It is also possible to vary the distance of anchoring elements 11 and 31 from each other within one of the groups 54 and 55. This insures a simple adaptation of the fastening element 51 to the site conditions.

For setting the fastening element 51 is a constructional component 44, firstly, a borehole 42 is drilled in the constructional component 44. The nominal diameter N of the borehole 42 is so selected that it is smaller than both the outer diameter D1 of the anchoring element 11 and the outer diameter D2 of the anchoring element 31. The borehole depth T is determined, on one hand, by the necessary anchoring length for the fastening element 51 and, on the other hand, by the space in front of the fastening element 51 necessary for receiving drillings and drilling dust produced during drilling of the borehole 42.

Thereafter, the borehole 42 is filled with a predetermined amount of the hardenable mass 43 and then the fastening element 51 is inserted in the borehole 42 with the setting direction end 56 of the shaft 52 first. The fastening element 51 is inserted in the borehole 42 manually or with use of a power tool.

During the insertion of the fastening element 51, the anchoring elements 11 and 31 scrap along the borehole wall so that the drillings sticking to the wall are substantially removed and are mixed in the hardenable mass 43 or are displaced to the borehole bottom. Anchoring elements 11 and 31 are, e.g., pushed on the shaft 52 or are screwed thereon. During the insertion of the fastening element 51, the hardenable mass 43 flows through or around of the anchoring elements 11 and 31 through the through-openings 17 and recesses 15 or the slots 33 and 35, so that the hardenable mass 43 and the drillings located therein uniformly intermix, and the anchoring elements 11 and 31 are completely embedded in the hardenable mass 43 after its hardening.

Alternatively, firstly, the fastening element 51 can be inserted in the borehole 42 and then the mass 43 is poured into the borehole 42. According to another alternative, firstly, a small amount of mass 43 is poured into borehole, then, the fastening element 51 is inserted in the borehole 42, and finally the remaining free space of the bore hole 42 is filled with a further amount of the hardenable mass 43.

Further, the shaft 52 of the fastening element 51 can be provided with an injection bore through which the hardenable mass 43 can be poured into the borehole 42 after or during insertion of the fastening element 51 in the borehole 42.

Even before hardening of the hardenable mass 43, the fastening element 51 is already loaded to a limited load level because the anchoring elements 11 and 31 mechanically anchor the fastening element 51 in the borehole 42. After hardening of the hardenable mass 43, the fastening element 51 is loaded to a maximally allowed level.

Because the outer circumference 14 or 34 of the anchoring elements 11 and 31 at least partially engages in the borehole wall, there is provided a sufficient contact area, which permits the use of a fastening arrangement 41 in a crushed concrete.

The fastening element 61, which is schematically shown in FIG. 5, has a shaft 62 with a thread-shaped outer profile 3, and an anchoring assembly 72 provided on the shaft 62 and formed of a plurality of flat ring-shaped anchoring elements 71 connected with each other in their edge regions 73.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A flat ring-shaped anchoring element (11; 31; 71) for mounting on a shaft (52; 62) of a fastening element (51; 61) provided with an outer profile (53), the ring-shaped anchoring element comprising a through-opening (12; 32) for the shaft (52; 62); and at least one compensation recess (13; 33) located radially outwardly of the through-opening (12; 32) and opening thereto.

2. An anchoring element according to claim 1, wherein an outer circumference (14; 34) of the anchoring element (11; 31) is provided with a shaped profile.

3. An anchoring element according to claim 1, wherein the anchoring element (11) has a wavy profile in a ring plane.

4. An anchoring element according to claim 1, wherein the anchoring element (11) has different thicknesses in a ring plane.

5. An anchoring element according to claim 4, wherein the thickness of the anchoring element increases radially outwardly, starting from the through-opening (12).

6. An anchoring element according to claim 1, comprising at least one through-opening (17) for a hardenable mass (43).

7. An anchoring element according to claim 1, wherein the anchoring element (11; 31; 71) is formed of metal.

8. An anchoring element according to claim 6, wherein the anchoring element (11; 31; 71) is formed by a stamping-bending process.

9. An anchoring element according to claim 1, wherein the anchoring element (11; 31; 71) is formed of a plastic material.

10. An anchoring element according to claim 8, wherein the anchoring element (11; 31; 71) is formed by an injection-molding process.

11. A fastening element (51; 61) for being anchored in a borehole (42) of a constructional component (41) with a hardenable mass (43), comprising a shaft (52; 62) having an outer profile (53; 63), and at least one flat ring-shaped anchoring element (11; 31; 71) having a through-opening (12; 32) for the shaft (52; 62), and at least one compensation recess (13; 33) located radially outwardly of the through-opening (12; 32) and opening thereto.

12. A fastening element according to claim 11, comprising a plurality of anchoring elements (11; 31) provided on the shaft (52) at distance from each other.

13. A fastening element according to claim 12, wherein the plurality of anchoring elements (11; 31) comprises anchoring elements having different shapes.

14. A fastening element according to claim 12, wherein at least two flat ring-shaped anchoring elements (71) are connected with each other at one of edge region thereof, forming an anchoring assembly.

15. A fastening arrangement (41) for anchoring a fastening element (52) in a borehole (42) of a constructional component (41) and having a nominal diameter (N) with a hardenable mass (43), the fastening element (51) comprising a shaft (52) having an outer profile (53), and at least one flat ring-shaped anchoring element (11; 31) having a through-opening (12; 32) for the shaft (52), and at least one compensation recess (13; 33) located radially outwardly of the through-opening (12; 32) and opening thereto, the anchoring element (11; 31) having an outer diameter (D1; D2) greater than the nominal diameter (N) of the borehole (42).
